(19) United States
(12) Patent Application Publication
(10) Pub. No.: US 2006/0065687 A1
(43) Pub. Date: Mar. 30, 2006

(54) Cargo carriage for a pickup truck

(76) Inventor: Leon Reed, Concord, NH (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/230,687

(22) Filed: Sep. 20, 2005

Related U.S. Application Data
(60) Provisional application No. 60/611,434, filed on Sep. 20, 2004.

(51) Int. Cl. B60R 9/00; B60R 7/00

(52) U.S. Cl. 224/404; 296/26.09; 296/37.6; 224/510; 224/281; 224/42.33; 224/526

(57) ABSTRACT

A cargo carrier assembly for use with a pickup truck or other cargo-carrying vehicle includes a movable tray for the bed of the pickup truck. The carriage includes wheels to roll along the bed between a storage/transit position within the bed when the tailgate is up or down, and an access/loading position on top of the tailgate when the tailgate is down. Also, there are retainer assemblies for retaining the tray in the stored position, as well as in the access position.

### CROSS-REFERENCE TO RELATED APPLICATION

This application claims the priority benefit of U.S. Provisional Patent Application Ser. No. 60/611,434, filed Sep. 20, 2004, the entire scope and content of which is hereby incorporated herein by reference.

### TECHNICAL FIELD

The present invention relates generally to cargo carriers and, in particular, to a cargo carriage for a pickup truck.

### BACKGROUND OF THE INVENTION

Pickup trucks are commonly used for hauling a variety of cargo such as groceries, luggage, golf clubs, fishing gear, hiking gear, camping gear, and tools and equipment. Pickup trucks can be used both for non-commercial purposes (e.g., for tailgate parties) and for commercial purposes (e.g., for painters, carpenters, service technicians, and delivery service). When putting objects in or taking objects out of the bed of the truck, the user typically has to reach over the walls of the bed and/or across the tailgate to place or access the objects. Because of this, there is really only a limited amount of reachable/useable space in the pickup truck bed even though the bed of the truck is in fact relatively large. FIGS. 1A and 1B show these large amounts of unusable/unreachable space, including the wheel-well locations that are generally unusable. FIG. 1A shows a pickup truck without a cap showing a significant portion of the space S as non-reachable and generally non-usable. FIG. 1B shows a pickup truck with a cap showing an even greater portion of the space S as non-reachable and generally non-usable.

When users try to reach for objects located in the non-reachable/non-usable space in the bed, users can become injured, such as from back strain from reaching and lifting heavy objects and/or climbing up and into the truck bed. In addition, when driving around, objects in the truck bed often roll around quite a bit. This can damage the objects and/or cause them to move to farther away from the sides of the bed where they are harder to reach.

Accordingly, it can be seen that a need exists for a way to reduce movement of objects in the bed of a pickup truck and to enhance user safety when putting objects into and taking them out of the bed of the truck. It is to such a solution that the present invention is primarily directed.

### SUMMARY OF THE INVENTION

In example forms, the present invention includes a carriage for retaining cargo in a bed of a vehicle with a tailgate. Preferably, the carriage includes a tray adapted for retaining the cargo therein; a plurality of wheels mounted to the tray and adapted for permitting the carriage to roll along the bed between a stored position (within the bed when the tailgate is up) and an access position (on top of the tailgate when the tailgate is down); and one or more retainer member assemblies adapted to restrain the tray in the stored position and the access position. The one or more retainer member assemblies may include an end-positioned retainer assembly and/or a side-mounted retainer strap assembly. The end-mounted retainer assembly has at least one retainer member and a pin that slips through an enlarged hinge gap between the tailgate and the bed when the tailgate is down, wherein the pin does not fit through the narrowed hinge gap when the tailgate is up, thereby retaining the carriage in the stored position. The side-mounted retainer strap assembly has two retainer members that are coupled between the tray and the vehicle, wherein the retainer members have a length such that the retainer members retain the carriage in the access position.

Optionally, the cargo carriage can further include a cover for the tray for containing cargo within the tray. Also optionally, the cargo carriage can further include a mechanical stop for securing the tray in the access position on the top of the tailgate when the tailgate is down and elevated.

In another aspect, tray can include at least three longitudinal wheel positions for the plurality of wheels. In this way, the wheels of at least two wheel positions are in contact with the bed or the tailgate its down position when the wheel of one other wheel position passes over a hinge gap between the bed and the tailgate.

The cargo carrier can further have a locking mechanism for securing the tray in the loading position when the tailgate of the vehicle is down but tilted from horizontal such that the tray is inclined to move rearward back into the bed. In one embodiment, the locking mechanism includes a pin that fits through a hole in the tray to engage the tailgate. In another embodiment, the locking mechanism includes a locking member with a lock arm and a handle. The locking member is movably mounted to the tray and movable between a locked position in which the lock arm extends downwardly and engages the tailgate and an unlocked position in which the lock arm is free of engagement with the tailgate. The locking member can be L-shaped and can be rotationally mounted to the tray.

In still another aspect, the present invention includes a method of using a carriage for retaining cargo in a bed of a vehicle with a tailgate. The method includes the steps of opening the tailgate of the vehicle; moving the carriage from the stored position to the access position so that at least one retainer member retains the carriage from falling off the end of the tailgate; loading one or more objects into the carriage without reaching into the bed of the vehicle; moving the carriage from the access position to the stored position so that at least one retainer member retains the carriage from movement in the bed; and closing the tailgate.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIGS. 1A and 1B are top views of prior art, conventional pickup trucks showing non-reachable and non-usable cargo area for both a pickup truck without a cap (FIG. 1A) and a pickup truck with a cap (FIG. 1B).

FIGS. 2 and 3 are perspective views of a carriage for a pickup truck in accordance with a first example embodiment of the present invention.

FIGS. 4A and 4B are side views of the carriage and the pickup truck of FIGS. 2 and 3.

FIG. 5 is a front view of the carriage of FIG. 2.

FIG. 6 shows a retainer belt assembly for the carriage of FIG. 2.

FIG. 7 shows a retainer strap assembly for the carriage of FIG. 2.

FIG. 8 is a side view of the carriage of FIG. 2.

FIGS. 9A and 9B are top views of the carriage and the pickup truck of FIG. 2, showing an access/loading position and a storage/transit position, respectively.

FIG. 10 is a side view of the carriage of FIG. 2, shown with an optional cover.

FIG. 11 is a top view of the carriage of FIG. 2, showing optional panels for compartmentalizing the tray portion of the carriage.

FIG. 12 shows example panels for compartmentalizing the tray portion of the carriage of FIG. 11.

FIGS. 13 and 14 are perspective views of a carriage for a pickup truck in accordance with a second example embodiment of the present invention.

FIG. 15 is a side view of the carriage and a portion of the pickup truck of FIG. 14.

FIGS. 16A and 16B are side views of a carriage for a pickup truck in accordance with a third example embodiment of the present invention.

FIG. 17 is a detailed, side view of the carriage of FIG. 16A.

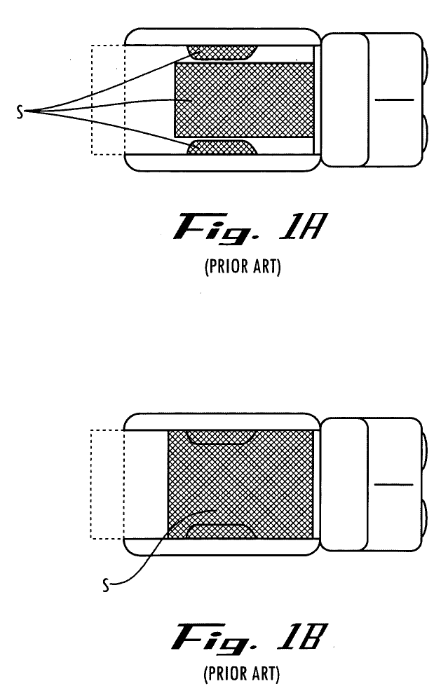

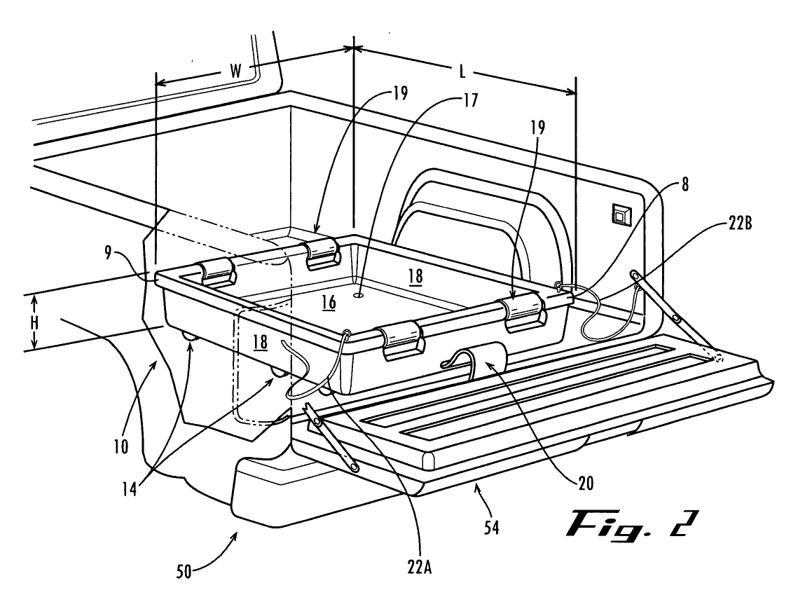

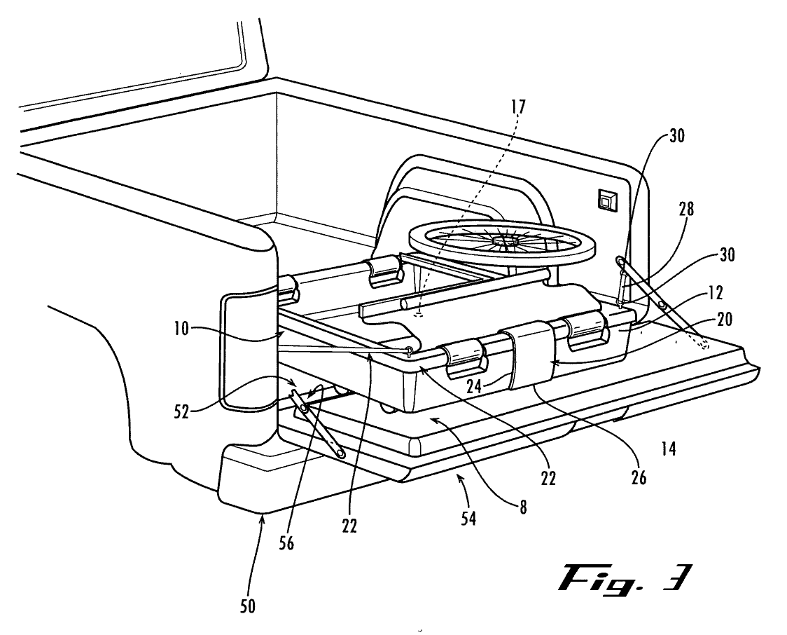

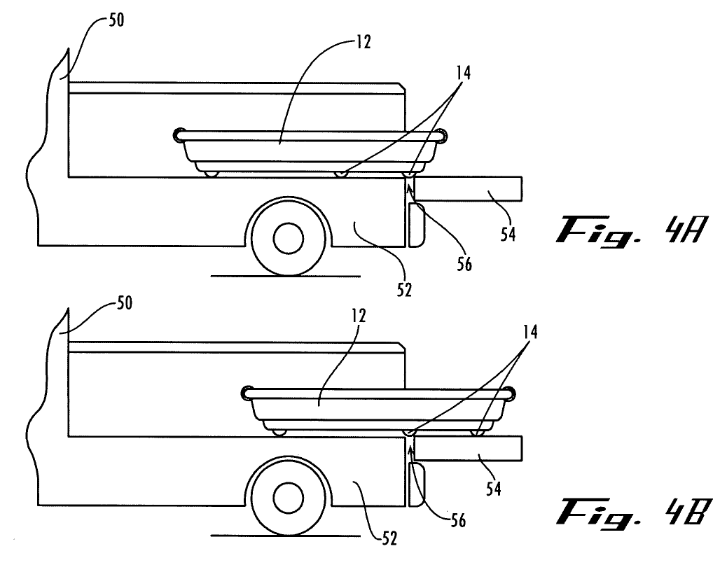

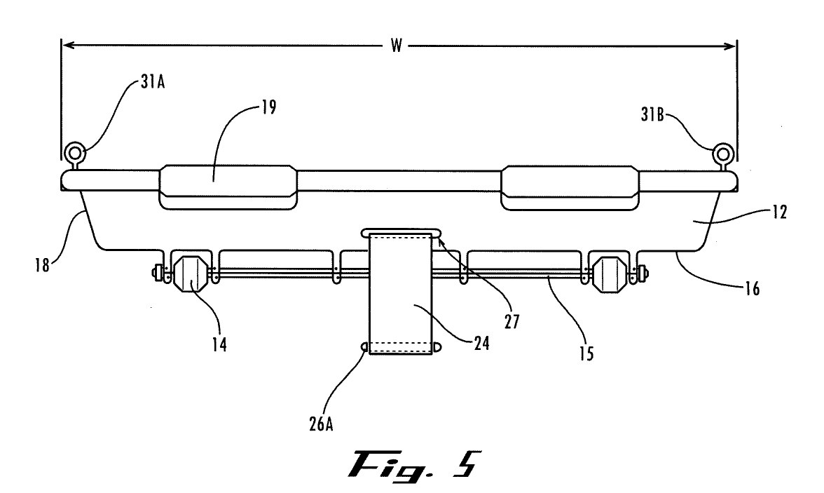

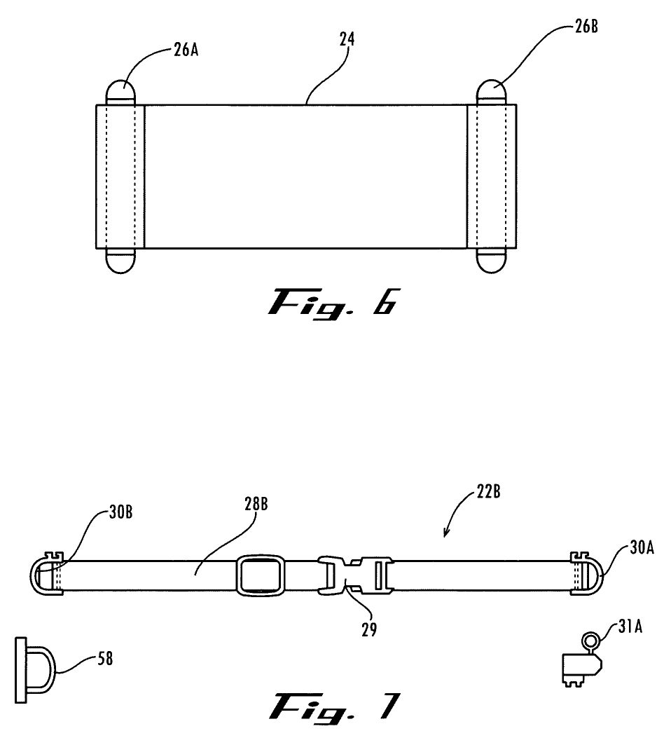

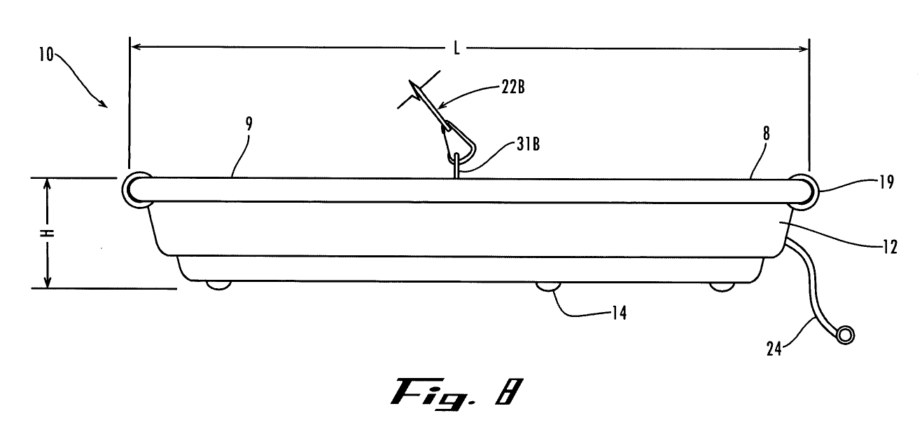

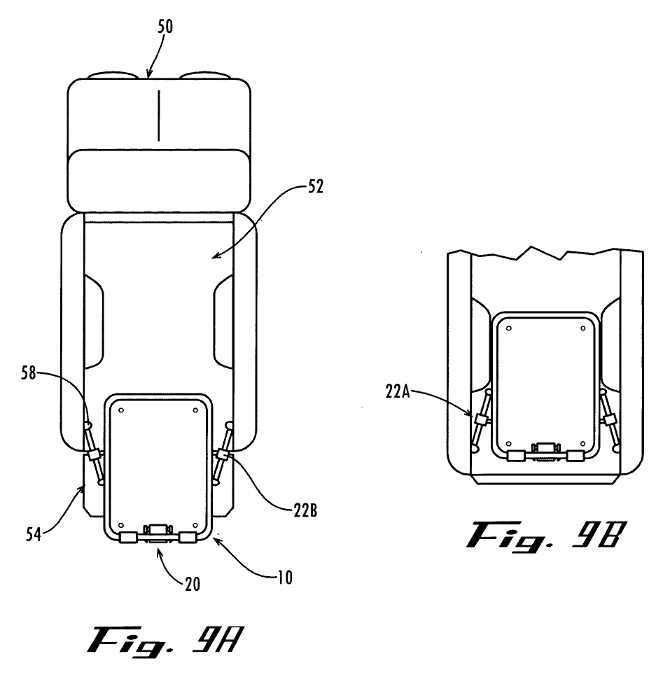

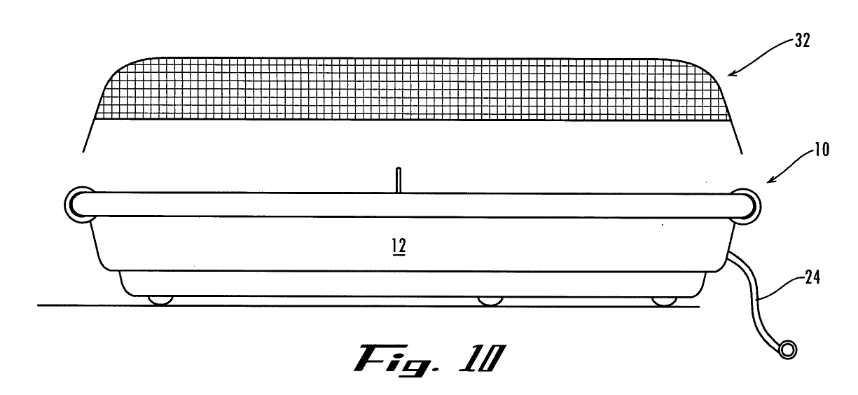

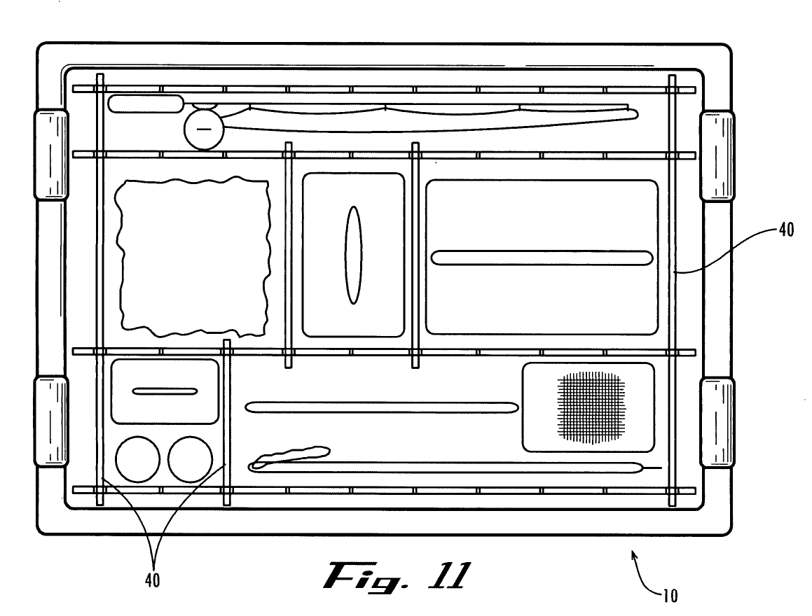

### DETAILED DESCRIPTION OF EXAMPLE EMBODIMENTS

Generally described, the present invention is a cargo carriage for use with a vehicle having a bed and a tailgate. It will be understood that the cargo carriage can be used with trucks having snap-on canvas-type covers over the beds, truck bodies with rollback-type covers, and truck bodies with pop-up metal-type covers. It will also be understood that the cargo carriage can be used with other tailgated vehicles such as station wagons and sport utility vehicles, and that the cargo carriage can be adapted for use with other hauling vehicles such as vans and flatbed trucks. The cargo carriage is designed to hold various types of cargo, including but not limited to groceries, luggage, golf clubs, fishing gear, hiking gear, camping gear, painting supplies, carpentry supplies, and service parts. Preferably, the cargo carriage has a lightweight design, no sharp or rough edges, and a load capacity of at least about 200 pounds evenly distributed over the carriage bottom. The carriage can be easily removed from the bed of the pickup truck to allow for normal truck use. Also preferably, no hardware or tools are required to attach or remove the carriage from truck bed.

FIGS. 2 and 3 show a cargo carriage 10 according to a first exemplary embodiment of the present invention. The cargo carriage 10 is designed for use with a pickup truck 50 having a bed 52 and a tailgate 54. A hinge gap 56 is formed between the tailgate 54 and the bed 52 when the tailgate is down. The cargo carriage 10 includes a tray 12 for retaining the cargo and a plurality of wheels 14 mounted to the tray. The tray 12 has a bottom panel 16 and a peripheral sidewall 18 extending upwardly from and all the way around the bottom panel. The sidewall 18 retains cargo items, such as groceries, supplies, etc., within the carriage and thereby keeps such items from rolling around in the bed 52 of the truck 50. Optionally, one or more drain holes 17 drain any fluids, such as rainwater, from the tray and keep the bottom panel 16 relatively dry. In the depicted embodiment, the tray has a length L of about 48″, a width W of about 36″, and a height H of about 7″, although those skilled in the art will understand that the dimensions indicated in these drawing figures are those for a typical commercial embodiment, are included for illustrative purposes only, and are not limiting of the invention. The tray 12 also includes a front/access/loading end portion 8 positioned proximate the tailgate 54 and a rear end portion 9 positioned near the cab of the pickup truck 50.

Preferably, the tray 12 is a unitary structure having a one-piece design made of a durable material that is also fade, peel, corrosion, and crack-resistant. For example, a thermoformed plastic having a load capacity of at least 200 pounds can be used. Alternatively, other durable materials can be used for the tray 12 as well, such as a metal or a wood, and still be within the scope of the present invention. Additionally, the tray 12 can include reinforced ribs in the bottom panel 16 for added strength and durability.

Preferably the tray includes one or more handles 19 with a smooth, positive grip for ease of handling and moving the tray 12 within the bed 52. The handles 19 aid in moving the tray 12 between the access and storage positions. In addition, the handles 19 are useful for handling the carriage 10 to remove it from the bed 52, as may be desired from time to time.

The wheels 14 permit the tray 12 to roll along the bed 52 between a storage/transit position (see FIG. 2) within the bed when the tailgate 54 is up or down, and an access/loading position (see FIG. 3) on top of the tailgate when the tailgate is down. Preferably, the wheels 14 are rigid casters or rollers to prevent side-to-side motion, are designed to support a load capacity of 200 pounds evenly distributed over the carriage bottom, and are corrosion resistant. In a typical commercial embodiment, the wheels 14 are made of a hard rubber-type material as is commonly used on boat trailers to minimize vibration when moving the carriage back and forth in the truck bed. Alternatively, the wheels can be constructed of various other materials that can sustain the weight of the tray 12. Preferably there are three sets of wheels, two wheels per set, to overcome load-bearing problems and to minimize side-to-side motion. Although six wheels 14 are included in the depicted embodiment, more or less can be used with good results. To accommodate various truck designs, the carriage can be provided in a few standardized designs with wheel spacings selected for use with certain predetermined models.

Conventional pickup truck beds have a plurality of longitudinal grooves therein. In one embodiment, the wheels 14 can be spaced apart across the width W of the tray 12 to roll within the channels or grooves of the bed of the pickup truck. If the width of the wheels is small enough to ride in the grooves and if the wheels are not precisely spaced, a situation could arise where some wheels roll within one of the grooves and other wheels roll above the grooves. Then the tray 12 would have a slight tilt to it, which although not optimal, is within the scope of the present invention. In a typical commercial embodiment, however, the wheels 14 have a width of about 1.0 inch such that they span across the channels to overcome the problem with the channels in the truck bed 52 or in a liner insert in the truck bed.

Additionally, as shown in FIGS. 4A and 4B, preferably there are three longitudinal positions for the wheels 14 which are spaced apart along the length L of the tray 12 so that at least two wheels (or sets of wheels) along the length L are in contact with the bed 52 of the pickup truck 50 or the tailgate 54 in its down position when one wheel (or set of wheels) passes over the hinge gap 56 between the tailgate 54 and the bed 52. In addition, the wheels in the intermediate and rear (cab end) positions support the tray if it is rolled too far and a little off the end of the tailgate. As shown in FIG. 5, each set of wheels can be parallel, laterally aligned, and connected by a single axle 15. In other embodiments, each wheel can rotate about a dedicated axle.

Alternatively, the wheels can be laterally adjustable for use with many different models of trucks. The adjustability may be provided by several hole patterns in the tray for bolting the wheels in several positions, with the unused holes serving as drain holes. Or the wheels can be mounted on lateral tracks and engaged/held in place by spring-biased pins alignable with and receivable in any of a series of laterally spaced holes, which arrangement permits the wheels to be disengaged, slid laterally to a desired position, and secured in place there. It will be understood that other lateral adjustment means may be used.

In lieu of wheels, a plurality of non-friction surface pads can be used to slide the tray 12 from its storage/transit position to its access/loading position. Moreover, the wheels could be entirely omitted from the carriage 10 such that the bottom panel 16 of the tray 12 slides along the bed of the truck.

The carriage 10 also includes one or more retainer members for securing the tray 12 in place. In the depicted embodiment, there is one front-end retainer belt assembly 20 for securing the tray 12 in the stored position and two side-mounted retainer strap assemblies 22A and 22B for securing the tray in the access position. As seen more clearly in FIG. 6, the retainer belt assembly 20 includes a belt 24 with a pair of pins 26A and 26B at each end. Preferably, the belt 24 can be a band constructed of a durable, yet flexible material such as a heavy gauge fabric or a plastic polypropylene material, although various other durable and flexible materials can be used as well. And each of the pins 26A and 26B may be provided by a dowel, rod, pipe, shaft, rigid wire, or the like, assembled onto the belt 24 or integrally manufactured as a part of the belt. In the depicted embodiment, the length of the belt 24 is about 3″ so as to limit the movement of the tray 12 towards the cab of the pickup truck. Those skilled in the art will understand that the retainer belt assembly can be configured in a number of ways and may have various dimensions. Also, the retainer belt can also include a length of cord, rope, chain, or other material so as to limit the distance the tray 12 can travel towards the cab of the truck 50.

The front-end retainer belt assembly 20 is preferably attached to the tray 12 by the belt 24 being inserted through a slot 27 in the tray (see FIG. 5) and retained therein by pin 26A. The other end of the belt 24 is inserted through the gap 56 between the bed 52 of the pickup truck 50 and the tailgate 54, and secured therein by pin 26B. In this way, the belt 24 can be slid out of the tray 12 (except for the inner pin 26A) for engagement in the tailgate hinge gap 56 when the carriage 10 is in the storage position. And the belt 24 can be slid back into the tray 12 (except for the outer pin 26B) to get it out of the way when the carriage 10 is in the access position. Alternatively, the belt 14 can be fixedly attached to the tray 12 by conventional means such as riveting or bolting. The hinge gap 56 is narrower when the tailgate 54 is up, and the pin 26B does not fit through the narrowed hinge gap 56. In this way, the retainer belt assembly 20 retains the tray 12 in the stored position shown in FIG. 2.

Additionally, the two side-mounted retainer strap assemblies 22A and 22B secure the tray 12 in its open access position. The retainer strap assemblies 22A and 22B are substantially similar, and thus only strap 22B will be discussed herein. The retainer strap assembly 22B includes a retainer strap 28B having two conventional end connectors 30A and 30B for connecting to the tray 12 and the truck 50. The retainer strap 28B has a length such that it is completely stretched out when the tray 12 is rolled to the access position. In the depicted embodiment, the retainer strap 28B has a length of about 18 inches, although those skilled in the art will understand that the dimensions indicated in these drawing figures are those for a typical commercial embodiment, are included for illustrative purposes only, and are not limiting of the invention. In this way, the retainer strap assemblies 22 retain the tray 12 in the access position shown in FIG. 3.

FIG. 7 shows details of the strap 28B and the end connectors 30A and 30B of the retainer strap assembly 22. The end connectors 30A and 30B may be provided by clips (or other conventional fasteners) suitable for coupling to eyelets 31A and 31B (or other cooperating conventional fasteners) on the tray 12 and to existing tie-down hooks 58 (or other cooperating conventional fasteners) on the truck 50. Alternatively, the retainer straps 28A and 28B can be permanently affixed to the tray 12. The eyelets 31A and 31B (or other cooperating conventional fasteners) are preferably positioned at an intermediate section of the tray 12 between its front end 8 and rear end 9, as depicted more clearly in FIG. 8. Alternatively, the eyelets 31A and 31B or other conventional fasteners can be positioned anywhere along the length L of the tray 12, and the length of the straps can be adjusted accordingly. In addition, the straps 28A and 28B optionally include an adjustment buckle 29 or other adjustment mechanism for lengthening and/or shortening the strap to a length selected for the particular model of truck and its bed length. Those skilled in the art will understand that there are various ways to configure the strap retainer assemblies and still be within the scope of the present invention.

FIGS. 9A shows a top view of the carriage 10 in the access/loading position, while FIG. 9B shows a top view of the carriage in the storage/transit position. In the access/loading position, the side retainer strap assemblies 22A and 22B are fully extended outwardly, thereby retaining the tray 12 from rolling further rearward and off of the tailgate 54. In this position, the end retainer belt assembly 20 is disengaged from the tailgate hinge gap 56 and so it does not restrain the tray 12.

Because the retainer strap assemblies 22 are coupled to the intermediate section of the tray 12, when rolling the tray 12 between the access/loading position and the storage/transit position, the retainer strap assemblies 22 go slack and then tauten up again. In the storage/transit position, the retainer strap assemblies 22 are fully extended inwardly, thereby retaining the tray 12 from rolling further forward into the truck bed 52. The length of the straps may be selected or adjusted so that they are fully extended when the tray 12 is just inside the bed 52, so the closed tailgate 54 retains the tray from rolling rearward.

Before closing the tailgate 54, the user inserts the end retainer belt assembly 20 through the tailgate hinge gap 56. Upon closing the tailgate 54, the retainer belt assembly 20 is engaged and locked in place, which restrains the tray 12 from rolling forward. In addition, when the truck is in motion the tray 12 can be jostled about, and the retainer belt assembly 20 helps hold the front end 8 of the tray 12 down in place. In an alternative embodiment, the carriage 10 does not include the retainer belt assembly, but instead uses only the retainer strap assemblies 22 for retaining the tray 12 in the access/loading and storage/transit positions. However, the retainer belt assembly 20 is preferably provided on all units to accommodate older series trucks that were not provided with tie-down hooks.

Optionally, the tray 12 can include a cover 32 as depicted in FIG. 10. The cover can be a piece of netting, as showing in the figure, for retaining the objects, or at least lighter objects, within the tray 12. Alternatively, the cover 32 can be a rain cover constructed of a water-resistant material to keep the contents of the tray 12 from getting wet. The cover 32 can be attached to the tray 12 by conventional fasteners such as, but not limited to, ties, straps, snaps, or the like, or the cover can include an elastic band or a pull string around the edge for securing the cover in place. Still alternatively, the cover 32 can be a rigid lid that is either hingedly secured to the tray 12 along one side or removable from the tray.

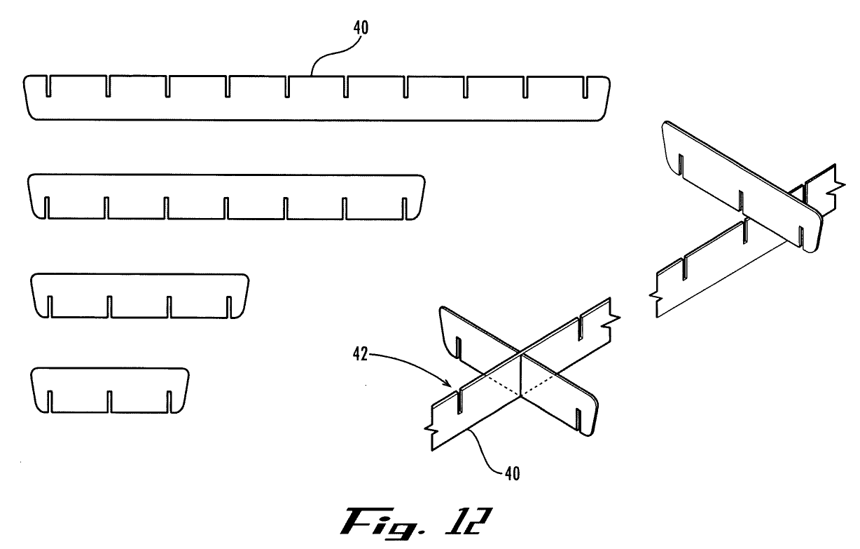

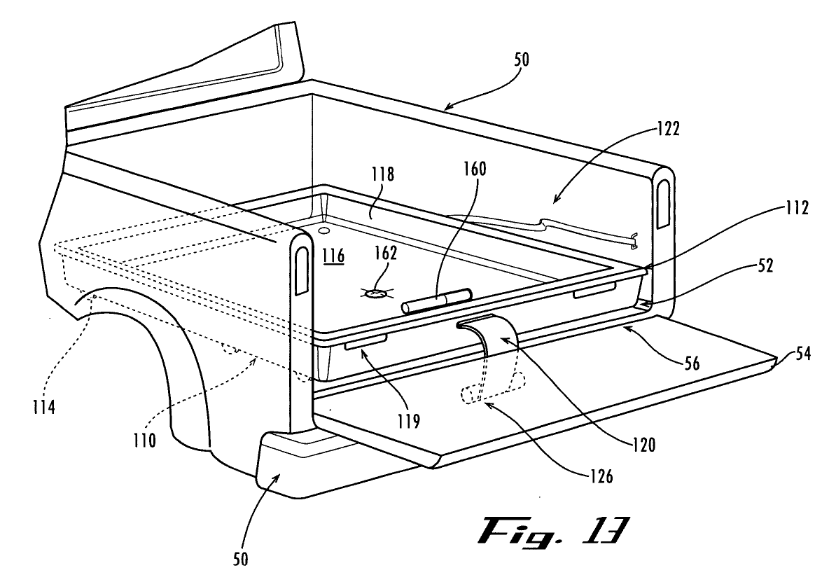

Also optionally, the tray can include a plurality of divider panels 40 for creating separate compartments for organizing and preventing movement of the cargo, as depicted in FIGS. 11 and 12. The divider panels 40 can be constructed of the same material as the tray 12, or the divider panels can be constructed of another durable material. Preferably, the divider panels 40 are removable from the tray, so that they can be inserted when needed and removed to accommodate larger objects. An exemplary configuration of the divider panels 40 is shown in FIG. 12. Each panel 40 can have one or more slits 42 for cooperating with a slit of another panel so that the two panels can be connected together perpendicularly to one another such that they are self-supporting in a generally upright position. Those skilled in the art will understand that there are various other ways to configure compartments within the tray of the carriage. Additionally or alternatively, the tray can include one or more drawers for sliding within the carriage.

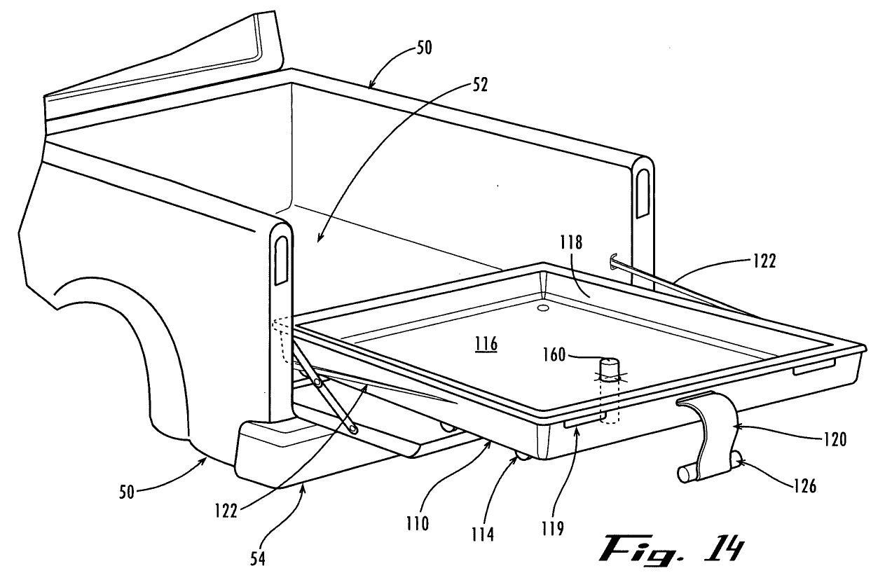

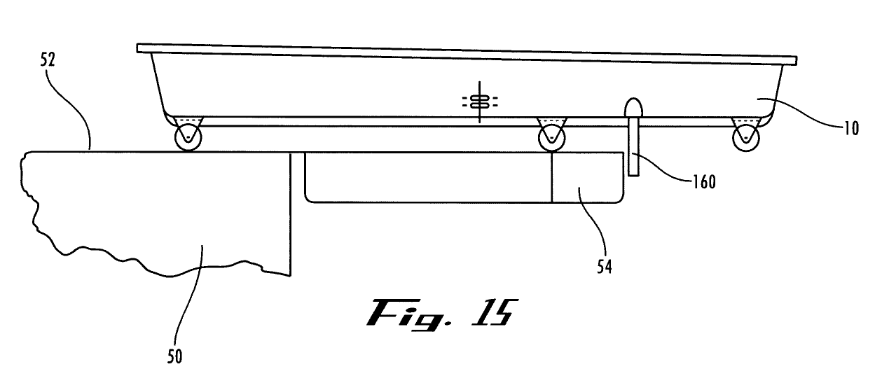

In a second exemplary embodiment shown in FIGS. 13-15, the carriage 110 is substantially similar to the carriage 10, with the addition of a tilt locking mechanism including a retainer pin 160 and a retainer pin hole 162. The retainer pin 160 fits snugly within the retainer pin hole 162 and is beneficial when loading and unloading the tray 112. The pin 162 is long enough to engage at least a portion of the tailgate 54 in its lowered position such that the pin acts as a mechanical stop against motion of the tray towards the cab of the pickup truck, as best shown in FIGS. 14 and 15. This pin is particularly useful when the truck 50 is parked on a downward slope (i.e. the cab of the pickup truck at a slightly lower elevation than its bed), such that gravity would urge the tray 112 towards the cab of the truck if there were no stop. When the pin 160 is not in use, it can be stored in the tray or in a compartment thereof.

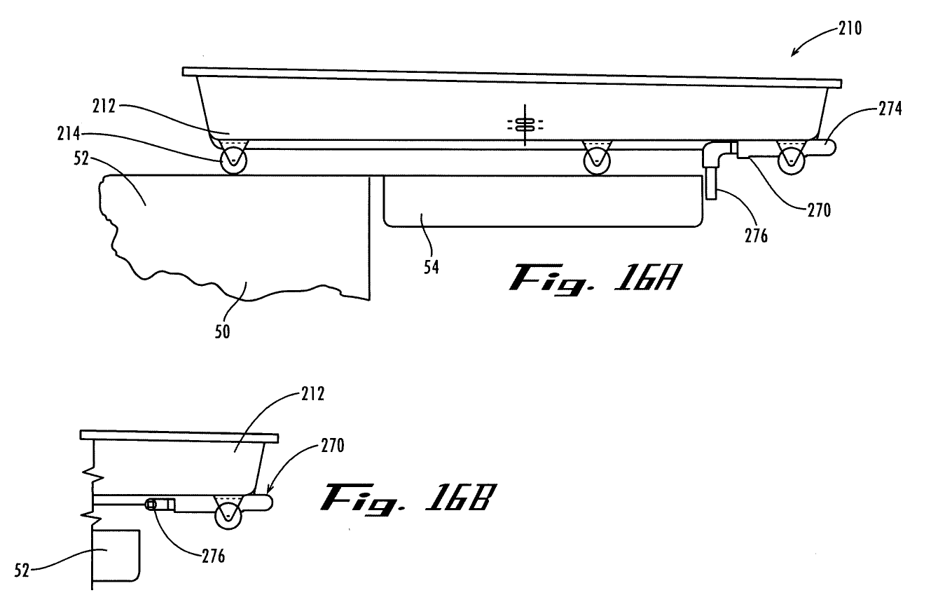

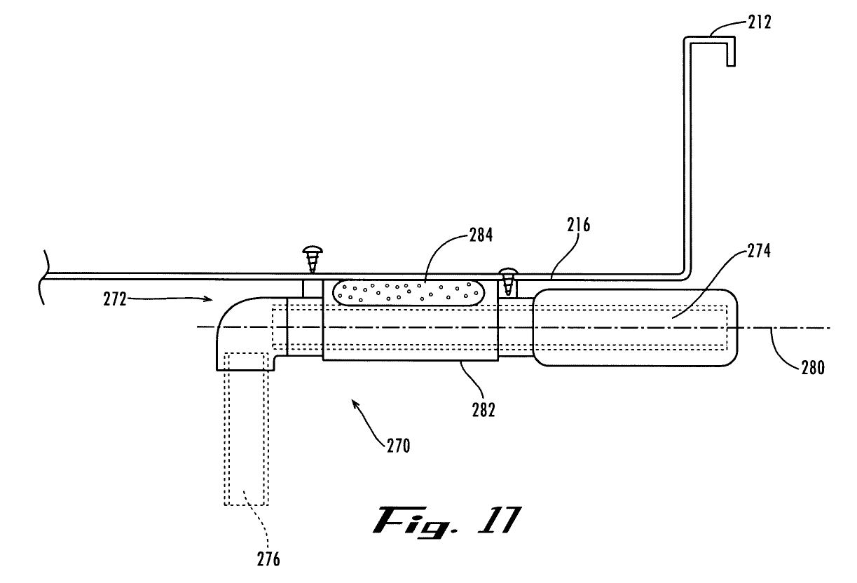

FIGS. 16A, 16B, and 17 show a third exemplary embodiment in which the carriage 210 includes a different tilt locking mechanism for preventing the tray 212 of the carriage 210 from rolling towards the cab of the pickup truck 50 when the cab of the pickup truck is at a slightly lower elevation than its bed. The tilt locking mechanism includes a locking member 270 having a handle 274 and a lock arm 276 that rotates about an axis 280. The locking member 270 is secured beneath the floor panel 216 of the tray 212 so that it is accessible to the user, while not interfering with the movement of the wheels 214. In the depicted embodiment the locking member 270 is generally L-shaped. For example, the L-shaped member maybe provided by two lengths of pipe of tubing perpendicularly coupled together by an el joint, and mounted to the tray by a bracket 282, with a friction pad 284 between the L-shaped member and the tray. When not in use, the lock arm 276 is generally parallel to the floor panel 216 such that the tilt locking mechanism does not interfere with any rolling of the cargo carriage 210, as shown in FIG. 16B. When the user is loading or unloading cargo, the user can pull the tray 112 to its access position and rotate the handle 274 ninety degrees or so about the axis 280 such that the lock arm 276 pivots downward so that it abuts the proximate edge of the lowered tailgate 54, as shown in FIG. 16A. Thus, the lock arm 276 provides a mechanical stop for the tray 212 against rearward motion towards the cab of the pickup truck.

In alternative embodiments, the carriage includes additional elements for securing down the rear end of the tray (toward the cab) when driving at high speeds and/or in high winds. For example, the carriage may include one or more rear-end retainer straps, a laterally extending retainer bar under which the tray can be rolled, and/or cooperating engagement members on the front end of the tray and mounted to the bed.

While the depicted embodiments include the side-mounted retainers and the end-mounted retainer only, in other embodiments the carriage includes the side-mounted retainers only, in other embodiments the carriage includes the end-mounted retainer only, and in other embodiments the carriage includes one of these retainers in combination with another type retainer.

In addition, other alternative embodiments include a sloped bottom panel for directing water and other liquids to the drain holes and out of the tray. For example, the bottom panel may be sloped back-to-front for directing water towards front drain holes, or it may be higher in the middle and sloped downward to both the front and the back for directing water towards front and back drain holes.

Accordingly, it can be seen that the present invention provides a carriage with a tray for storing cargo in the back of a pickup truck or other vehicle. Advantageously, the carriage of the present invention allows a user of a pickup truck to easily access otherwise unreachable space with minimal effort. The user can lower the tailgate and pull the tray outwardly to load and unload cargo in the tray, and then push the tray into the bed of the truck when finished loading or unloading the cargo. Because the user of the pickup truck makes use of space otherwise unreachable without significant effort, the user does not risk back strain when loading and unloading the bed of the pickup truck.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A carriage for retaining cargo in a bed of a vehicle with a tailgate, comprising:
a tray adapted for retaining the cargo therein;
a plurality of wheels mounted to the tray and adapted for permitting the carriage to roll along the bed between a stored position within the bed when the tailgate is up and an access position on top of the tailgate when the tailgate is down; and
two or more retainer member assemblies adapted to restrain the tray in the stored position and the access position,
wherein a first one of the retainer member assemblies comprises an end-positioned retainer assembly having at least one retainer member and a pin that slips through an enlarged hinge gap between the tailgate and the bed when the tailgate is down, wherein the pin does not fit through the hinge gap when the tailgate is up, thereby retaining the carriage in the stored position; and
wherein a second one of the retainer member assemblies comprises a side-mounted retainer member assembly having two or more retainer members that are coupled between the tray and the vehicle, wherein the retainer members have a length such that the retainer members retain the carriage in the access position from moving forward off the tailgate.

2. The carriage of claim 1, wherein the tray has a bottom panel and a peripheral sidewall extending upwardly from and all the way around the bottom panel.

3. The carriage of claim 1, further comprising a cover for the tray for containing cargo within the tray.

4. The carriage of claim 1, further comprising a mechanical stop for securing the tray in the access position on the top of the tailgate when the tailgate is down but still elevated relative to horizontal.

5. A method of using the cargo carriage of claim 1, comprising:
opening the tailgate of the vehicle;
moving the carriage from the stored position to the access position so that at least one of the retainer members retains the carriage from moving forward past an end of the tailgate;
loading the cargo into the carriage without reaching into the bed of the vehicle;
moving the carriage from the access position to the stored position so that at least one of the retainer members retains the carriage from movement in the bed; and
closing the tailgate.

6. A cargo carrier for a vehicle, comprising:
a repositionable tray for placement between a first, cargo-loading position and a second, cargo-storage position; and
at least one retaining member assembly for securing the tray to the vehicle in the cargo-loading position and in the cargo-storage position.

7. The cargo carrier of claim 6, wherein the tray includes a plurality of wheels for rolling the tray between the cargo-loading and cargo-storage positions.

8. The cargo carrier of claim 7, wherein the cargo carrier includes at least three longitudinal wheel positions for the plurality of wheels such that the wheels of at least two wheel positions are in contact with a bed or a down-positioned tailgate of the vehicle when the wheel of one other wheel position passes over a hinge gap between the bed and the tailgate.

9. The cargo carrier of claim 6, wherein the at least one retaining member assembly comprises a pair of side-mounted retainer members, each releasably fastened to the tray and the vehicle, wherein the retainer members have a length such that the retainer members retain the carriage in the access position from moving forward off the tailgate, and each retaining member is taut in the access position and has some slack as the tray is moved toward the access position.

10. The cargo carrier of claim 9, wherein at least one of the retainer members is adjustable to accommodate various vehicles.

11. The cargo carrier of claim 6, wherein the at least one retaining member assembly comprises an end-mounted retainer member that is secured to the tray at a first end of the retaining member and is releasably securable to the vehicle at a second end of the retaining member, and a pin that is coupled to the retainer member and that slips through the hinge gap between the tailgate and the bed when the tailgate is down but does not fit through the hinge gap when the tailgate is up, thereby retaining the carriage in the stored position when the tailgate is up.

12. The cargo carrier of claim 6, further comprising a cover for containing cargo within the tray.

13. The cargo carrier of claim 6, wherein the tray includes dividers forming at least two compartments.

14. The cargo carrier of claim 6, further comprising a tilt locking mechanism adapted to secure the tray in the loading position when a tailgate of the vehicle is down but still elevated relative to horizontal.

15. The cargo carrier of claim 14, wherein the tilt locking mechanism includes a locking member that is movably mounted to the tray and movable between a locked position in which a lock arm of the locking member extends downwardly and engages the tailgate and an unlocked position in which the lock arm is free of engagement with the tailgate.

16. The cargo carrier of claim 15, wherein the locking member is L-shaped.

17. The cargo carrier of claim 15, wherein the locking member is rotationally mounted to the tray.

18. The cargo carrier of claim 6, wherein the tray has a bottom panel with at least one drain hole for draining fluid from the tray.

19. The cargo carrier of claim 6, wherein the cargo carrier is removable from the vehicle.

20. The cargo carrier of claim 6, wherein the at least one retaining member includes a pair of side-mounted retainer members, each releasably fastened to both the tray and the vehicle, and an end-mounted retainer member that is secured to the tray at one end and is releasably securable to the vehicle at its other end.
